(19) United States
(12) Patent Application Publication
(10) Pub. No.: US 2013/0142590 A1
(43) Pub. Date: Jun. 6, 2013

(54) Fastening Element

(71) Applicant: Uwe Frank, Pfedelbach-Windischenbach (DE)

(72) Inventor: Uwe Frank, Pfedelbach-Windischenbach (DE)

(21) Appl. No.: 13/817,078

(22) PCT Filed: Aug. 23, 2011
(86) PCT No.: PCT/EP2011/064465

§ 371 Date: Feb. 14, 2013

(30) Foreign Application Priority Data
Aug. 24, 2010 (DE) 10 2010 039 671.0

(51) Int. Cl. F16B 35/00; F16B 15/00

(52) U.S. Cl. CPC F16B 35/005; F16B 15/00
USPC 411/386; 411/493; 411/497

(57) ABSTRACT

A fastening element, which may be in the form of a blind rivet or screw, is intended to be fired into an unperforated workpiece. In its front region that is intended to be fired into the workpiece, it includes a punching section which is formed in a cylindrical manner, and has a front end face which extends obliquely to the longitudinal axis. The punching section may be smaller in diameter than the body of the fastening element or else have the same diameter. The section between the end face and the outer side of the punching section forms a punching edge. On account of the oblique profile of the end face, said punching edge is arranged such that, when the fastening element is fired in, the punching edge first of all strikes the metal sheet at one or else at two points, and the opening in the metal sheet is enlarged by shearing off the metal sheet at a point migrating around the circumference.

The invention relates to a fastening element which is driven into a non-perforated underlying surface in an abrupt movement.

There is already known a gun rivet, which is driven into a non-perforated workpiece with the aid of a firing device. At its end facing the workpieces, the rivet mandrel thereof has a tip which can also be formed in a pyramid shape (EP 1085952). Such a tip, which is conventional in gun rivets, makes penetration into the non-perforated workpiece easier.

However, it has been found that, in certain applications, the deformation, caused by such a tip, of the workpiece in the region of the fastening point leads to unsuitable results.

The invention is based on the object of creating a fastening element suitable for driving into a non-perforated workpiece, said fastening element having a simple structure and leading to less deformation of the workpiece in the region of the fastening brought about by the fastening element.

In order to achieve this object, the invention proposes a fastening element having the features mentioned in claim 1. Developments of the invention are the subject matter of dependent claims.

Thus, in the region of its front end facing the workpieces, the fastening element has no tip, but rather a punching section having an end face which is bounded by an encircling circumferential edge. This end face, and thus also the circumferential edge bounding it, are not now located in a plane which extends transversely to the longitudinal axis. This leads to the circumferential edge of the end face hitting the workpiece first of all at a point or tip, such that the opening of the workpiece begins there. Starting from said tip, the circumferential edge extends in a circumferential direction in the form of a cutting edge, and, in the event of a plurality of tips, this is the case for at least one cutting edge. Upon further penetration of the punching section, all points of the punching edge(s) gradually come into contact with the workpiece, such that the opening is produced gradually, in a manner similar to shearing. As a result, the workpiece is deformed less severely in the region of the opening and also there is no excessive braking of the fastening element. In addition, on account of the shearing of a part of the workpiece, a hole with a clean periphery is produced. Such a clean periphery does not tend to tear, as can occur in the case of a hole produced by a tip.

In particular, it may be provided that the circumferential edge has at least one section in which said circumferential edge extends (approximately) parallel to the longitudinal axis of the fastening element.

In order that such a clean hole can be punched even under aggravated conditions, according to the invention it may be provided in a development for the front punching section of the fastening element to have a cylindrical, in particular a circular-cylindrical, outer contour.

In a further development of the invention, it may be provided for the at least one punching edge to be formed by a section line between the end face of the fastening element and a cylindrical outer contour of the fastening element, preferably by the cylindrical outer contour of the punching section.

In a further development of the invention, it may be provided for the punching section to have a smaller cross section than the actual body of the fastening element. It has been found that the formation of a hole with a smaller cross section than corresponds to the cross section of the fastening element leads to good results in the configuration of the fastening and also means that the effort or force for driving in such a fastening element does not become too large.

In order to achieve this, it may be provided according to the invention for a transitional section which establishes the transition between the larger cross section and the smaller cross section to be arranged and formed between the front punching section and the fastening element body.

This transitional section can then have various shapes. For example, the transitional section can extend in a conical manner, that is to say with a rectilinearly extending side line.

It is likewise possible and is proposed by the invention for the transitional section to extend in a ballistic manner, i.e. for the side line to be convexly curved.

A further possibility proposed by the invention is for the transitional section to have a concavely curved side line.

In particular, it may also be provided for the side line of the transitional section to be composed of sections having different configurations, i.e. ballistic, conical and concave sections.

It has already been mentioned that the oblique profile of the end face is intended to lead to the punching edge striking the workpiece at different times or gradually in order thereby to carry out a shearing operation. This can also be achieved by a more complicated shape of the end face being used in order thereby to even more gradually place the punching edge on the workpiece. For example, it may be provided in a development of the invention that the punching edge starting from a leading point extends along a line which gradually approaches the head of the fastening element and leads around the circumference of the fastening element. In particular, this line can lead along a complete turn around the fastening element. For example, this line may be a helical line. The punching operation is then carried out as a shearing operation along a point migrating around the circumference. The punching edge is then indeed closed in an end view, but not in a side view.

It is similarly possible for the punching edge starting from two leading points or tips to extend along in each case a line which gradually approaches the head of the fastening element and leads partially around the circumference of the fastening element, preferably along a half turn in each case.

In a further development of the invention, it may be provided that the end face is formed in a stepped manner with an outer part and an inner projection, wherein both the outer part of the end face and the inner projection are each surrounded by a punching edge.

The arrangement of an inner projection within the end face with a dedicated punching edge has the advantage that the beginning of the fastening operation of the workpiece proceeds closer to the center of the hole to be produced or closer to the axis of the fastening element. This can be advantageous there if the fastening element has to be very precisely oriented perpendicularly to the surface of the workpiece. There is thereby less tendency to tilt when driving in the rivet.

In particular, it may be provided in a development that the punching edge of the projection merges into the punching edge of the outer part of the end face.

The punching edge extends along a closed line, preferably a circular line, as seen in an end view.

According to the invention, it may be provided that the at least one cutting edge extends along at least half of the circumference of the end face of the fastening element.

It may advantageously be provided according to the invention to match the fastening element to the workpieces in such a manner that the at least one cutting edge has an axial height which corresponds at least to the thickness of the workpieces to be connected.

The fastening element can be in the form for example of a gun rivet. However, it may also be in the form of a screw which can be fired into the workpiece until an opening is formed in the workpiece in the manner of a rim hole, it being possible to screw the thread of the screw into said opening in order to shape the mating thread there.

It is also conceivable for the fastening element to have encircling grooves which do not form a thread but can contribute toward better fixing.

Further features, details and advantages of the invention will become apparent from the claims and the abstract, the wording of both of which is incorporated into the content of the description by reference, from the following description of preferred embodiments of the invention and by way of the drawing, in which:

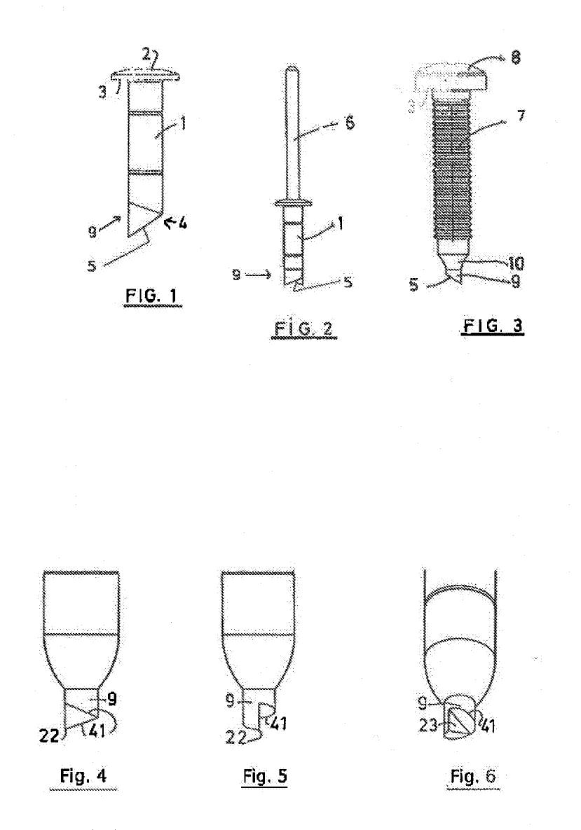

FIG. 1 shows the side view of a fastening element in the form of a hollow rivet;

FIG. 2 shows the side view of a fastening element in the form of a breakstem rivet;

FIG. 3 shows the side view of a fastening element in the form of a punch screw;

FIG. 4 shows the side view of a punching section with a circumferential edge running along a helical line;

FIG. 5 shows a side view of the embodiment of FIG. 4 from a direction shifted through 90°;

FIG. 6 shows the perspective view of the embodiment according to FIG. 4 and FIG. 5;

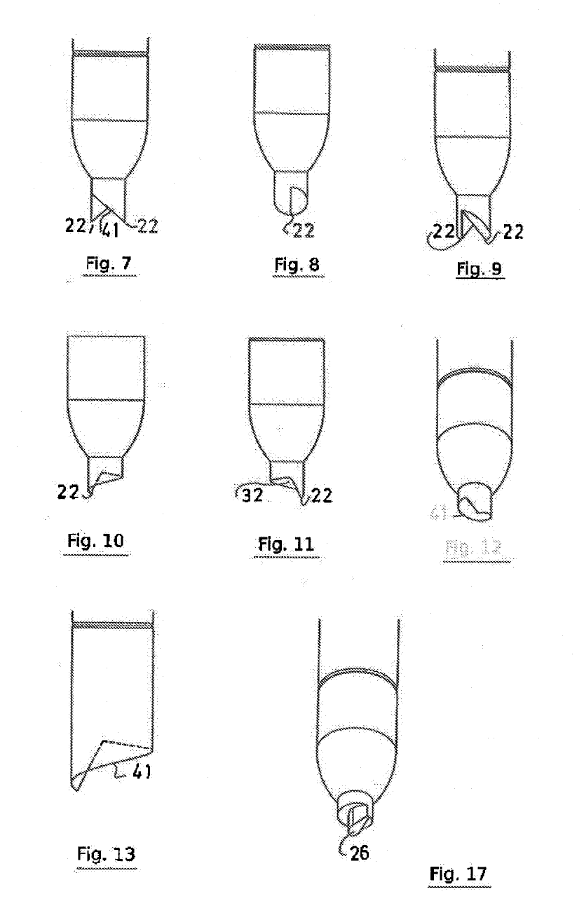

FIG. 7 shows the side view of a punching section with two sections of the circumferential edge;

FIG. 8 shows the side view of the embodiment of FIG. 7 from a direction shifted through 90°;

FIG. 9 shows the side view of the embodiment of FIGS. 7 and 8 from a further direction;

FIG. 10 shows a punching section with an encircling punching edge;

FIG. 11 shows the side view of the embodiment according to FIG. 10 from a direction shifted through 180°;

FIG. 12 shows a perspective view of the embodiment of FIGS. 10 and 11;

FIG. 13 shows the front end of a fastening element without a transitional region and with formation of a circumferential edge corresponding to FIG. 10;

FIG. 14 shows a fastening element with an end face formed in a stepped manner;

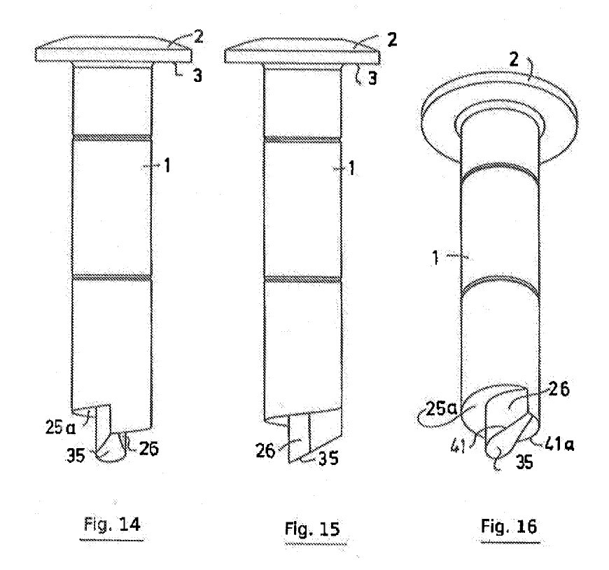

FIG. 15 shows the side view of the embodiment according to FIG. 14 from a direction shifted through 90°;

FIG. 16 shows a perspective view of the fastening element of FIGS. 14 and 15;

FIG. 17 shows a punching section with formation of an end face corresponding to FIG. 16.

FIG. 1 shows, as an example of a fastening element proposed by the invention, a hollow rivet having a body 1, at one end of which a head 2 is formed. The head 2 protrudes radially beyond the cylindrical body 1 of the fastening element. Its underside forms an abutment shoulder 3 which comes into abutment with the top side of the workpiece in the fastened state. In the region of its front end 4 assigned to the workpiece, the fastening element has an end face 5, which is merely indicated here.

A second example of the type of fastening element in which the invention can be used is illustrated in FIG. 2. This is a breakstem rivet, the body 1 of which looks exactly the same as the body 1 of the fastening element in FIG. 1. In the body 1 of the breakstem rivet there is located a rivet mandrel 6, which is pulled to form a rivet head.

A third example of a fastening element by which the invention can be realized is illustrated in FIG. 3. This is a punch screw having a fastening element body 7, at one end of which a screw head 8 is arranged. The underside of the screw head forms an abutment shoulder 3 as in the previous fastening elements.

Formed in the region of the front end, that is to say that end of the fastening element that is remote from the screw head 8, is a punching section 9 which is bounded by an end face 5 extending obliquely. Between the cylindrical body 7 of the fastening element and the likewise cylindrical punching section 9 there is formed a transitional section 10 which has a concavely curved side line in the example illustrated.

FIGS. 4 to 6 which now follow show an embodiment, in which the punching edge 41 does not extend along a closed path. Starting from a point or tip 22, the cutting edge 41 extends around the cylindrical punching section along a helical line and ends in the circumferential direction at the same point at which it has also started, but shifted axially. By this means, the front end of the punching section 9 has a side face 23 lying in a longitudinal center plane. The advantage of such an embodiment is that, during punching, the punching spot is sheared at a point which continues in one direction along a circumference. The front edge of the side face 23 is also a cutting edge.

The embodiment of FIGS. 7 to 9 practically contains a doubling of the type of shearing as in the embodiment according to FIGS. 4 to 6, since cutting or shearing is now undertaken at two points on the circumference. The punching edge 41 extends from two points or tips 22 through half the circumference in each case with an increasing axial distance from the two leading points. The punching spot is sheared here at two points along the circumference. Said two points run in the same direction around the circumference of the punching section.

FIGS. 10 to 12 in turn show an embodiment in which the punching edge 41 has an increasing distance along a circumference from a leading end 22. The end of this profile is then connected to the tip 22 via a flank 32 which does not extend parallel to the longitudinal axis.

FIG. 13 shows that such a profile of the punching edge 41 is also possible in a fastening element without a transitional section.

FIGS. 14 to 16 now show yet another embodiment, in which the end face 25 is formed in a stepped manner. The end face contains an outer part 25a, within which there is arranged a projection 26 which, for its part, has an end face 35. The end face of the projection 26 extends obliquely to the longitudinal axis and is surrounded by a punching edge 41. The punching edge 41 then merges into the punching edge 41a of the outer section 25a of the end face. This punching edge 41a extends in the manner of the embodiment according to FIGS. 4 to 6, i.e. along a line which has a gradually decreasing distance from the head 2 of the fastening element. For example, said punching edge can extend on a helical line, specifically through precisely one turn. The embodiment which has just been described has the advantage that the beginning of the punching operation begins closer to the center axis of the fastening element.

As in the other embodiments, the design of the front end of the fastening element can be realized both in the case of fastening elements having a punching section 9 of reduced diameter and in the case of a fastening element having a punching section which is not reduced in diameter. This is indicated by FIG. 17.

The fastening element can be driven into a non-perforated underlying surface in an abrupt movement, for example into two metal sheets lying one above the other, and therefore the cutting edges are used in a punching operation.

1. A fastening element for driving in, having
a fastening element body (1, 7) which
has a head (2, 8) having an abutment shoulder (3) on its underside, and
a punching section (9) which forms the front end of the fastening element and
has an end face (5, 15, 25, 35) bounded by a circumferential edge (41), which end face
is not located in a transverse plane that extends perpendicularly to the longitudinal axis, wherein
the circumferential edge (41) is formed in at least one section as a punching edge, and
for at least one of said cutting edges starting from a tip of the cutting edge, cutting is undertaken only in one direction.

2. The fastening element as claimed in claim 1, wherein the punching section (9) has a cylindrical, in particular circular-cylindrical outer contour.

3. The fastening element as claimed in claim 1, wherein the circumferential edge (41) is formed by a section line between the end face (5, 15, 25, 35) and a cylindrical outer contour of the fastening element, preferably the cylindrical outer contour of the punching section (9).

4. The fastening element as claimed in one of the preceding claims, having
a transitional section (10) arranged and formed between the front punching section (9) and the fastening element body (1, 7), wherein
the cross section of the punching section (9) is smaller than the cross section of the fastening element body (1, 7).

5. The fastening element as claimed in claim 4, wherein the transitional section (10) extends at least partially in a conical or concave manner.

6. The fastening element as claimed in claim 4, wherein the transitional section (10) is formed at least partially in a ballistic manner.

7. The fastening element as claimed in claim 1, wherein the cutting edge (41) starting from a leading point (22) extends along a line which gradually approaches the head of the fastening element (2, 8) and leads around the circumference of the fastening element, preferably along a complete turn.

8. The fastening element as claimed in claim 1, wherein the cutting edge (41) starting from two leading points (22) extends along in each case a line which gradually approaches the head (2, 8) of the fastening element and leads partially around the circumference of the fastening element, preferably along a half turn in each case.

9. The fastening element as claimed in claim 1, wherein the end face (25) is formed in a stepped manner with an outer part (25 a) and an inner projection (26), which are both surrounded by a cutting edge (41) bounding them.

10. The fastening element as claimed in claim 9, wherein the circumferential edge (41) of the projection (26) merges into the circumferential edge (41) of the outer part (25 a) of the end face.

11. The fastening element as claimed in claim 1, wherein the circumferential edge (41), as seen in an end view, extends along a closed circular line.

12. The fastening element as claimed in claim 1, wherein at least one cutting edge (41) extends along at least half of the circumference of the end face (5).

13. The fastening element as claimed in claim 1, wherein the at least one cutting edge (41) has an axial height which corresponds at least to the height of the workpieces to be connected.

14. The fastening element as claimed in claim 1, wherein the fastening element body is in the form of a screw or of a rivet body.
